(19) United States
(12) Patent Application Publication
(10) Pub. No.: US 2026/0120655 A1
(43) Pub. Date: Apr. 30, 2026

(54) ELECTRONIC PAPER DISPLAY DEVICE AND DRIVING METHOD

(71) Applicant: E Ink Holdings Inc., Hsinchu (TW)

(72) Inventors: Chi-Liang Wu, Hsinchu (TW); Wei-Tsung Chen, Hsinchu (TW); Chia-Hao Kuo, Hsinchu (TW)

(73) Assignee: E Ink Holdings Inc., Hsinchu (TW)

(21) Appl. No.: 19/366,525

(22) Filed: Oct. 23, 2025

Related U.S. Application Data
(60) Provisional application No. 63/711,705, filed on Oct. 25, 2024.

(51) Int. Cl. G09G 3/34

(52) U.S. Cl. CPC G09G 3/344; G09G 2300/0408; G09G 2310/0267; G09G 2310/0286; G09G 2320/0247; G09G 2330/021

(57) ABSTRACT

Provided are an electronic paper display (EPD) device and a driving method thereof. The electronic paper display device comprises an electronic paper display panel and a gate driver on array, the EPD panel and the gate driver on array in the EPD device are disposed on an EPD substrate, and the EPD panel includes N scan lines. The driving method includes: controlling the gate driver on array to scan the N scan lines. The steps of scanning the N scan lines include: a first group of scan lines among the N scan lines is sequentially scanned X times when one frame of the EPD panel is scanned; and a second group of scan lines among the N scan lines is sequentially scanned Y times after the first group of scan lines is sequentially scanned X times.

### CROSS-REFERENCE TO RELATED APPLICATION

This application claims the priority benefit of U.S. provisional application serial no. 63/711,705, filed on October 25, 2024. The entirety of the above-mentioned patent application is hereby incorporated by reference herein and made a part of this specification.

### BACKGROUND

### Technical Field

The disclosure relates to electronic paper display (EPD) technology, and particularly to an electronic paper display device and its driving method.

### Related Art

An electronic paper display may utilize incident light (such as sunlight or indoor ambient light) to illuminate an electronic ink layer to display a frame, and therefore does not need a backlight source. Moreover, the electronic paper display needs to scan and update data on a display panel when switching frames, and does not need to consume power to maintain the frame like a liquid crystal display or a light-emitting diode display, and therefore saves more power.

When the electronic paper display switches frames, since a manner of progressive scan is utilized for scanning and updating the display panel, users might experience a strong frame flicker sensation. Therefore, how to reduce the frame flicker sensation when the electronic paper display switches frames is a research direction.

### SUMMARY

The disclosure provides an electronic paper display device and a driving method thereof, which can reduce a frame flicker sensation when an electronic paper display switches frames.

The driving method of the electronic paper display device of the disclosure is provided. The electronic paper display device comprises an electronic paper display panel and a gate driver on array, wherein the electronic paper display panel and the gate driver on array in the electronic paper display device are disposed on an electronic paper display substrate, the electronic paper display panel comprises N scan lines, and the N is even. The driving method includes the following steps: controlling the gate driver on array to scan the N scan lines. The steps of scanning the N scan lines include: a first group of scan lines among the N scan lines is sequentially scanned X times when one frame of the electronic paper display panel is scanned; and a second group of scan lines among the N scan lines is sequentially scanned Y times after the first group of scan lines is sequentially scanned X times. The X and the Y are positive integers.

The electronic paper display device of the disclosure includes an electronic paper display panel, a display controller, and a gate driver on array. The electronic paper display panel includes N scan lines. The gate driver on array is coupled to the display controller and the electronic paper display panel. The electronic paper display panel and the gate driver on array are disposed on an electronic paper display substrate. The display controller controls the gate driver on array to scan the N scan lines. When one frame of the electronic paper display panel is scanned, the gate driver on array sequentially scans a first group of scan lines among the N scan lines X times. After the first group of scan lines is sequentially scanned X times, the gate driver on array sequentially scans a second group of scan lines among the N scan lines Y times. The X and the Y are positive integers.

Based on the above, when one frame of the electronic paper display panel is scanned, the embodiments of the disclosure utilize an interlaced scan implemented by a novel interlaced timing (that is, through first sequentially scanning the first group of scan lines (such as odd-level scan lines) X times, and then sequentially scanning the second group of scan lines (such as even-level scan lines) Y times), which can reduce the flicker sensation to human eyes when the electronic paper display device switches pages. Moreover, the embodiments of the disclosure use a gate driver on array (GOA) circuit architecture to implement the foregoing interlaced scan, which can save power consumption.

### BRIEF DESCRIPTION OF THE DRAWINGS

FIG. 1 is a schematic diagram of an electronic paper display device according to an embodiment of the disclosure.

FIG. 2 is a schematic diagram of an interlaced scan implemented by an interlaced timing according to an embodiment of the disclosure.

FIG. 3 is a flowchart of a driving method of an electronic paper display device according to an embodiment of the disclosure.

FIG. 4 is a schematic diagram of a detailed structure of a gate driver on array according to an embodiment of the disclosure.

FIG. 5 is a signal timing diagram of the time periods T210-1 and T210-2 in FIG. 2 according to an embodiment of the disclosure.

FIG. 6 is a signal timing diagram of the time periods T220-1 and T220-2 in FIG. 2 according to an embodiment of the disclosure.

### DESCRIPTION OF THE EMBODIMENTS

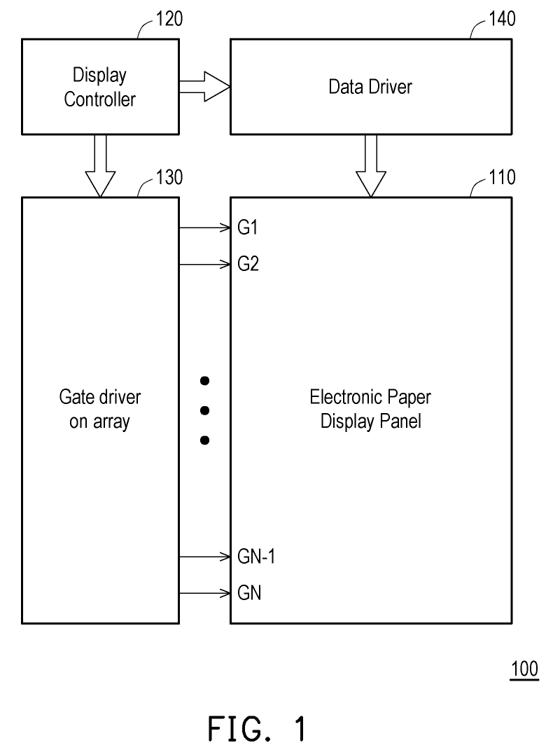

FIG. 1 is a schematic diagram of an electronic paper display device 100 according to an embodiment of the disclosure. The electronic paper display device 100 mainly includes an electronic paper display panel 110, a display controller 120, and a gate driver on array (GOA) 130. The electronic paper display device 100 further includes a data driver 140.

The electronic paper display panel 110 includes N scan lines G1 to GN. The N is a positive integer, and the N is even. In the embodiment, a resolution of the electronic paper display panel 110 is exemplified as 1920X1440. That is to say, the electronic paper display panel 110 has 1440 scan lines (that is, N is 1440). Each of the scan lines G1 to GN has 1920 pixel units. The display controller 120 is, for example, a timing controller, which is configured to control the gate driver on array 130 and the data driver 140 to refresh display data on the electronic paper display panel 110 through scanning the scan lines G1 to GN. The display controller 120 may control the gate driver on array 130 and the data driver 140 through providing signals such as a voltage control clock signal VCK, a vertical synchronization signal CST, or a reset signal RST.

The gate driver on array 130 and the electronic paper display panel 110 of the embodiment are disposed on a same electronic paper display substrate. In other words, the gate driver on array 130 and the electronic paper display panel 110 are disposed in a relatively close distance. The gate driver on array 130 may rapidly enable the corresponding scan lines G1 to GN. The data driver 140 may rapidly provide data on one of the enabled scan lines G1 to GN to the multiple pixel units on one of the enabled scan lines G1 to GN.

The display controller 120 controls the gate driver on array 130 to scan the N scan lines G1 to GN. In the embodiment of the disclosure, an interlaced scan implemented by an interlaced timing is utilized for a method of scanning the N scan lines G1 to GN. That is, when one frame of the electronic paper display panel 110 is scanned, the gate driver on array 130 is controlled to sequentially scan a first group of scan lines among the N scan lines X times, and then sequentially scan a second group of scan lines (such as even-level scan lines) Y times, thereby completing the scan of one frame. The X and the Y are respectively positive integers. The X and the Y of the embodiment are each greater than or equal to 1 and less than or equal to 5. The X of the embodiment may be equal to the Y. The first group of scan lines is one of an odd-level scan line and an even-level scan line among the N scan lines. The second group of scan lines is another one of the odd-level scan line and the even-level scan line.

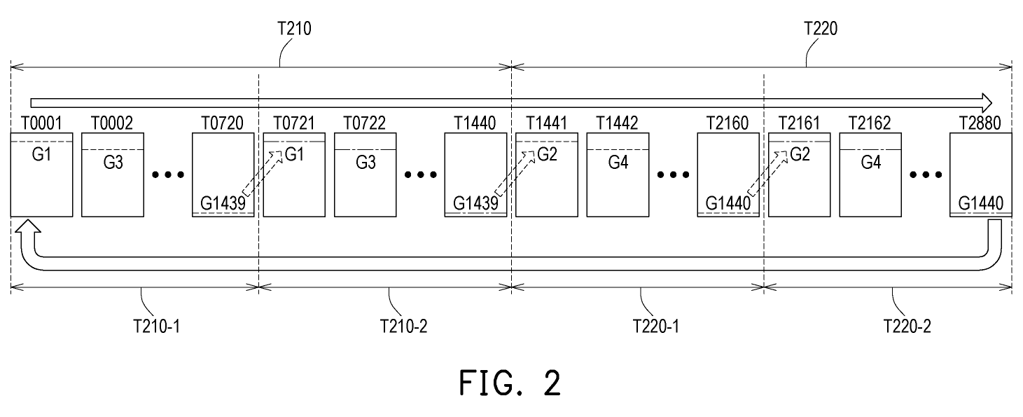

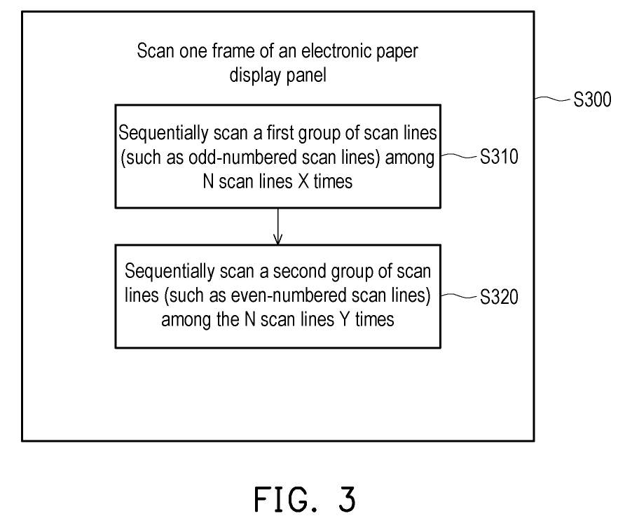

FIG. 2 is a schematic diagram of an interlaced scan implemented by an interlaced timing according to an embodiment of the disclosure. FIG. 3 is a flowchart of a driving method of an electronic paper display device according to an embodiment of the disclosure. For convenience of describing the embodiment, “the interlaced scan implemented by the interlaced timing” is abbreviated as “the interlaced scan” herein. FIG. 2 takes the electronic paper display panel 110 with a resolution of 1920X1440 as an example. The electronic paper display panel 110 has 1440 scan lines G1 to GN. In the embodiment of FIG. 2, the X and the Y are set as 2, and the N is set as 1440.

In FIG. 2, the interlaced scan divides a time for scanning one frame of the electronic paper display panel 110 into 2880 (that is, N/2×X+N/2×Y) scan time periods T0001 to T2880. That is, the scan time of one frame is divided into 2880 scan steps. Those applying the embodiment may extend an overall scan time of one frame, thereby dividing the overall scan time into 2880 scan steps. Those applying the embodiment may also shorten the time needed for each scan step, thereby performing 2880 scan steps within the original overall scan time of one frame.

Please refer to FIG. 2 and FIG. 3 at the same time. In step S300, the display controller 120 controls the gate driver on array 130 to scan 1440 (that is, the N) scan lines G1-G1440 to scan one frame of the electronic paper display panel 110. In step S310, when one frame of the electronic paper display panel 110 is scanned, a first group of scan lines (such as odd-level scan lines G1, G3, G5, ... and G1439) among the 1440 scan lines G1-G1440 is sequentially scanned twice (that is, the X), as shown in a time period T210 in FIG. 2.

The time period T210 in FIG. 2 includes a time period T210-1 and a time period T210-2. The time period T210-1 is a time period for sequentially performing a first scan on the odd-level scan lines. The time period T210-1 includes scan time periods T0001 to T0720. The time period T210-2 is a time period for sequentially performing a second scan on the odd-level scan lines. The time period T210-2 includes scan time periods T0721 to T1440. In the time period T210-1, the display controller 120 controls the gate driver on array 130 to sequentially scan the odd-level scan lines G1, G3, G5, ... and G1439 in the scan time periods T0001 to T0720, and then enters the time period T210-2 from the time period T210-1. In the time period T210-2, the display controller 120 controls the gate driver on array 130 to sequentially scan the odd-level scan lines G1, G3, G5, ... and G1439 in the scan time periods T0721 to T1440. Therefore, in the time period T210 in FIG. 2, the first group of scan lines (such as the odd-level scan lines G1, G3, G5, ... and G1439) has been sequentially scanned twice (that is, the X).

In step S320, after the first group of scan lines is sequentially scanned X times, a second group of scan lines among the 1440 scan lines G1 to G1440 (such as even-level scan lines G2, G4, G6, ... and G1440) are sequentially scanned twice (that is, the Y), as shown in a time period T220 in FIG. 2.

The time period T220 in FIG. 2 includes a time period T220-1 and a time period T220-2. The time period T220-1 is a time period for sequentially performing a first scan on the even-level scan lines. The time period T220-1 includes scan time periods T1441 to T2160. The time period T220-2 is a time period for sequentially performing a second scan on the even-level scan lines. The time period T220-2 includes scan time periods T2161 to T2880. In the time period T220-1, the display controller 120 controls the gate driver on array 130 to sequentially scan the even-level scan lines G2, G4, G6, ... and G1440 in the scan time periods T1441 to T2160, and then enters the time period T220-2 from the time period T220-1. In the time period T220-2, the display controller 120 controls the gate driver on array 130 to sequentially scan the even-level scan lines G2, G4, G6, ... and G1440 in the scan time periods T2161 to T2880. Therefore, in the time period T210 in FIG. 2, the second group of scan lines (such as the even-level scan lines G2, G4, G6, ... and G1440) has been sequentially scanned twice (that is, the Y). If the frame is to be continuously updated, the scan time period T2880 may return to the scan time period T0001 to continue to cyclically perform the foregoing “interlaced scan” starting from the scan time period T0001 in FIG. 2.

In the embodiment, when one frame of the electronic paper display panel 110 is scanned, a same scan line may be scanned multiple times. The data provided to this scan line each time the same scan line is scanned may be the same or different. Those applying the embodiment may, according to needs and based on characteristics of the pixel units on the electronic paper display panel 110, respectively provide the same or different data to the same scan line in different scan time periods during the scan of the same frame (such as a sum of the time period T210 and the time period T220) to maintain or adjust a brightness of the pixel units, thereby reducing a flicker sensation to human eyes when the electronic paper display panel 110 switches frames, which can also reduce power consumption.

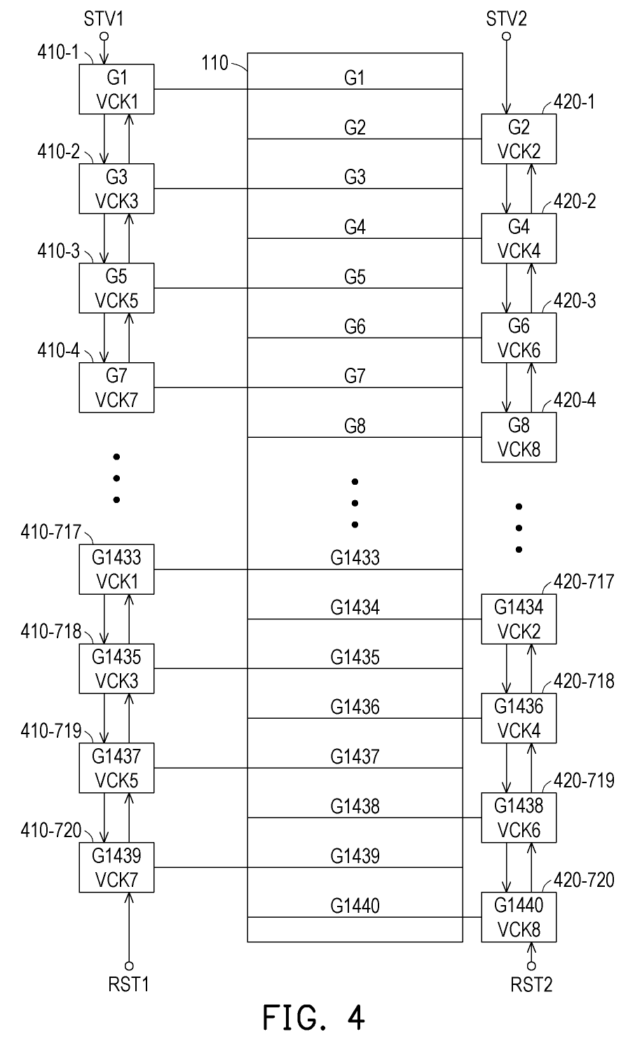

The gate driver on array of the embodiment of the disclosure may be implemented by various circuit structures to enhance driving performance. A circuit structure in FIG. 4 is taken as an example for description.

FIG. 4 is a schematic diagram of a detailed structure of the gate driver on array 130 according to an embodiment of the disclosure. FIG. 4 takes the electronic paper display panel 110 with a resolution of 1920X1440 as an example. The gate driver on array 130 in FIG. 2 may include 720 (that is, N/2) first gate selection circuits 410-1 to 410-720 and 720 (that is, the N/2) second gate selection circuits 420-1 to 420-720 in FIG. 4. The first gate selection circuits 410-1 to 410-720 and the second gate selection circuits 420-1 to 420-720 may respectively be a gate driver on array stage (GOA stage) circuit.

The first gate selection circuits 410-1 to 410-720 are disposed on a first side of the electronic paper display panel 110 (such as a left side of FIG. 4). Each of the first gate selection circuits 410-1 to 410-720 is respectively coupled to one of the odd-level scan lines among the 1440 scan lines. For example, the first gate selection circuit 410-1 is coupled to the scan line G1, the first gate selection circuit 410-2 is coupled to the scan line G3, the first gate selection circuit 410-3 is coupled to the scan line G5, and so on. The first gate selection circuits 410-1 to 410-720 are controlled by an enable signal STV1, voltage control clock signals VCK1, VCK3, VCK5 and VCK7 and a reset signal RST1.

A previous stage first gate selection circuit (such as the first gate selection circuit 410-1) may provide a signal VST to a next stage first gate selection circuit (such as the first gate selection circuit 410-2) to be set as a set trigger, allowing the next stage first gate selection circuit (such as the first gate selection circuit 410-2) to scan the corresponding scan line G3 due to a corresponding voltage control clock signal (such as the voltage control clock signal VCK3). A next stage first gate selection circuit (such as the first gate selection circuit 410-2) may provide the signal RST to a previous stage first gate selection circuit (such as the first gate selection circuit 410-1) to be set as a reset trigger, allowing the previous stage first gate selection circuit (such as the first gate selection circuit 410-1) not to scan the corresponding scan line G1 due to a corresponding voltage control clock signal (such as the voltage control clock signal VCK1). Therefore, the embodiment of the disclosure may selectively and sequentially scan the odd-level scan lines by adjusting the enable signal STV1, the voltage control clock signals VCK1, VCK3, VCK5 and VCK7, and the reset signal RST1.

For example, when a certain gate selection circuit 410-N (such as the first gate selection circuit 410-3) is set as a set trigger, if the gate selection circuit 410-N (such as the first gate selection circuit 410-3) receives a corresponding and enabled voltage control clock signal (for example, the voltage control clock signal VCK5 corresponding to the first gate selection circuit 410-3 is enabled), the corresponding scan line G5 may be scanned. In contrast, when a certain gate selection circuit 410-N (such as the first gate selection circuit 410-719) is set as a reset trigger, the gate selection circuit 410-N (such as the first gate selection circuit 410-719) may not scan the corresponding scan line G1437 regardless of whether the voltage control clock signal VCK5 is enabled or not.

The second gate selection circuits 420-1 to 420-720 are disposed on a second side of the electronic paper display panel 110 (such as a right side of FIG. 4). Each of the second gate selection circuits 420-1 to 420-720 is respectively coupled to one of the even scan lines among the 1440 scan lines. For example, the second gate selection circuit 420-1 is coupled to the scan line G2, the second gate selection circuit 420-2 is coupled to the scan line G4, the first gate selection circuit 420-3 is coupled to the scan line G6, and so on. The second gate selection circuits 420-1 to 420-720 are controlled by an enable signal STV2, voltage control clock signals VCK2, VCK4, VCK6 and VCK8, and a reset signal RST2. Similar to the control mechanism of the first gate selection circuits 410-1 to 410-720, the embodiment of the disclosure may selectively and sequentially scan the even scan lines by adjusting the enable signal STV2, the voltage control clock signals VCK2, VCK4, VCK6 and VCK8, and the reset signal RST2.

The gate driver on array circuit structure presented in FIG. 4 may be referred to as a single-side input gate driver on array circuit architecture. Each of the scan lines G1 to G1440 is respectively driven by a single gate selection circuit, such as one of the first gate selection circuits 410-1 to 410-720 or the second gate selection circuits 420-1 to 420-720. Those applying the embodiment may also use a dual-side input gate driver on array circuit architecture. For example, each of the scan lines G1 to G1440 is respectively driven by two gate selection circuits to strengthen a driving of the scan lines G1 to G1440.

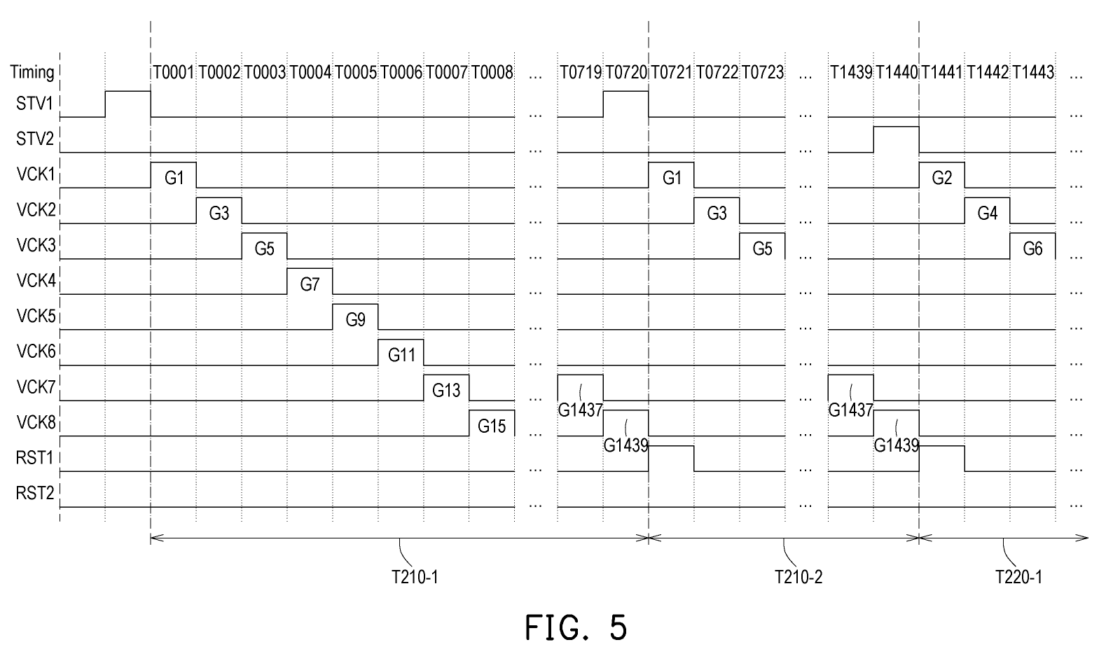

FIG. 5 is a signal timing diagram of the time periods T210-1 and T210-2 in FIG. 2 according to an embodiment of the disclosure. Please refer to FIG. 4 and FIG. 5 at the same time. The embodiment of the disclosure may implement the “interlaced scan” in FIG. 2 through adjusting the enable signals STV1 to STV2, the voltage control clock signals VCK1 to VCK8, and the reset signals RST1 to RST2.

In detail, before the scan time period T0001 of the time period T210-1, the enable signal STV1 is enabled. The other signals (such as the enable signal STV2, the voltage control clock signals VCK1 to VCK8 and the reset signals RST1 to RST2) are all disabled. During the scan time period T0001 of the time period T210-1, the voltage control clock signal VCK1 is enabled, allowing the first gate selection circuit 410-1 to scan the scan line G1. During the scan time period T0002, the voltage control clock signal VCK2 is enabled, allowing the first gate selection circuit 410-2 to scan the scan line G3.

By analogy, during the scan time period T0720, the voltage control clock signal VCK8 is enabled, allowing the first gate selection circuit 410-720 to scan the scan line G1439. Moreover, before the scan time period T0721 of the time period T210-2 (that is, the scan time period T0720), the enable signal STV1 is enabled, thereby starting to sequentially perform a second scan on the odd-level scan lines (as shown in the time period T210-2 in FIG. 2 and FIG. 5). After the time period T210-1 (that is, the scan time period T0721), the reset signal RST1 is enabled to complete a first sequential scan on the odd-level scan lines (as shown in the time period T210-1 in FIG. 2 and FIG. 5).

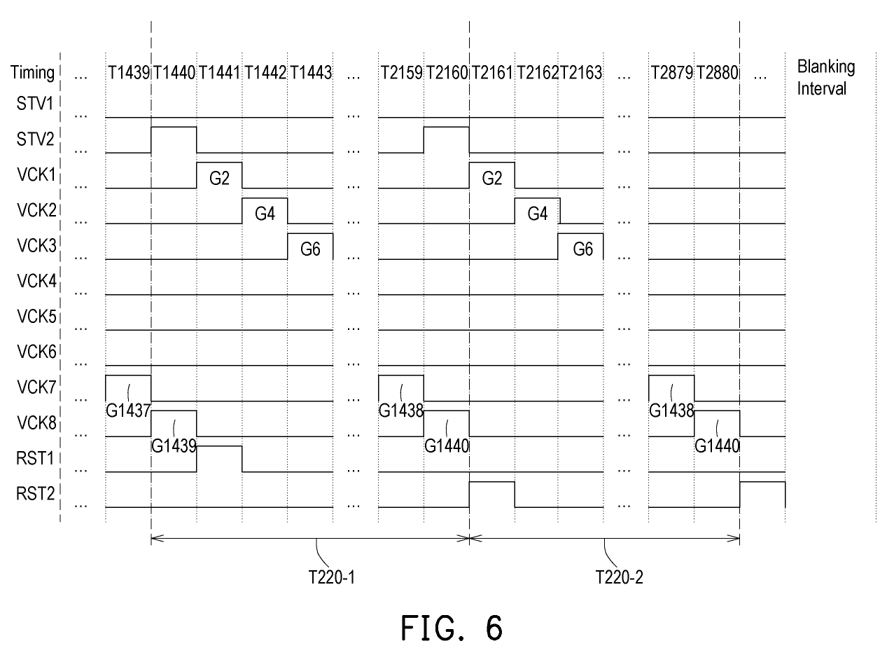

FIG. 6 is a signal timing diagram of the time periods T220-1 and T220-2 in FIG. 2 according to an embodiment of the disclosure. Please refer to FIG. 4, FIG. 5 and FIG. 6 at the same time. During the scan time period T1440, the voltage control clock signal VCK8 is enabled, allowing the first gate selection circuit 410-720 to scan the scan line G1439. Moreover, before the scan time period T1441 of the time period T220-1 (that is, the scan time period T1440), the enable signal STV2 is enabled, thereby starting to sequentially perform a first scan on the even-level scan lines (as shown in the time period T220-1 in FIG. 2 and FIG. 5). After the time period T210-2 (that is, the scan time period T1441), the reset signal RST1 is enabled to complete the second sequential scan on the odd-level scan lines (as shown in the time period T210-2 in FIG. 2, FIG. 5 and FIG. 6).

During the scan time period T1441 of the time period T220-1, the voltage control clock signal VCK1 is enabled, allowing the second gate selection circuit 420-1 to scan the scan line G2. During the scan time period T1442, the voltage control clock signal VCK2 is enabled, allowing the second gate selection circuit 410-2 to scan the scan line G4.

By analogy, during the scan time period T2160, the voltage control clock signal VCK8 is enabled, allowing the second gate selection circuit 420-720 to scan the scan line G1440. Moreover, before the scan time period T2161 of the time period T220-2 (that is, the scan time period T2160), the enable signal STV2 is enabled, thereby starting to sequentially perform a second scan on the even-level scan lines (as shown in the time period T220-2 in FIG. 2 and FIG. 6). After the time period T220-1 (that is, the scan time period T2161), the reset signal RST2 is enabled to complete the first sequential scan on the even-level scan lines (as shown in the time period T220-1 in FIG. 2 and FIG. 6).

During the scan time period T2880, the voltage control clock signal VCK8 is enabled, allowing the second gate selection circuit 420-720 to scan the scan line G1440. After the time period T220-2 (that is, after the scan time period T2880), the reset signal RST2 is enabled to complete the second sequential scan on the even-level scan lines (as shown in the time period T220-2 in FIG. 2, FIG. 5 and FIG. 6), and a blanking interval of the frame scan is entered.

Referring to FIG. 4, FIG. 5 and FIG. 6 at the same time, the first gate selection circuits 410-1 to 410-720 are configured to drive the odd-level scan lines, and the second gate selection circuits 420-1 to 420-720 are configured to drive the even-level scan lines. The first gate selection circuits 410-1 to 410-720 and the second gate selection circuits 420-1 to 420-720 respectively have their respective enable signals STV1 and STV2 and reset signals RST1 and RST2.

When the electronic paper display panel 110 is performing display, the embodiment utilizes the enable signals STV1 and STV2 to respectively drive the odd scan lines (such as the time periods T210-1 and T210-2) (referred to as a drive mode 1) and the even scan lines (such as the time periods T220-1 and T220-2) (referred to as a drive mode 2). Whether in the drive mode 1 or the drive mode 2, half of the scan lines may be maintained at a state of low level, and this half of the scan lines may not have pulses.

The embodiment utilizes the eight voltage control clock signals VCK1 to VCK8 to implement the “interlaced scan” in FIG. 2 and FIG. 5. Those applying the embodiment may adjust a quantity of voltage control clock signals according to needs. For example, four, six, eight, sixteen or thirty-two voltage control clock signals may be utilized to implement the embodiment. The quantity of voltage control clock signals is at least four, and the quantity should be even.

In summary, when one frame of the electronic paper display panel is scanned, the embodiments of the disclosure utilize the interlaced scan implemented by a novel interlaced timing (that is, through first sequentially scanning the first group of scan lines (such as the odd-level scan lines) X times, and then sequentially scanning the second group of scan lines (such as the even-level scan lines) Y times, which can reduce the flicker sensation to human eyes when the electronic paper display device switches pages. Moreover, the embodiments of the disclosure utilize the gate driver on array (GOA) circuit architecture to implement the foregoing interlaced scan, which can save power consumption.

What is claimed is:

1. A driving method for an electronic paper display device, wherein the electronic paper display device comprises an electronic paper display panel and a gate driver on array, wherein the electronic paper display panel and the gate driver on array in the electronic paper display device are disposed on an electronic paper display substrate, the electronic paper display panel comprises N scan lines, and the N is even,
the driving method comprising:
controlling the gate driver on array to scan the N scan lines,
wherein the steps of scanning the N scan lines comprise:
sequentially scanning a first group of scan lines among the N scan lines X times when scanning one frame of the electronic paper display panel; and
sequentially scanning a second group of scan lines among the N scan lines Y times after sequentially scanning the first group of scan lines X times, wherein the X and the Y are positive integers.

2. The driving method according to claim 1, wherein the first group of scan lines is one of an odd-level scan line and an even-level scan line among the N scan lines,
wherein the second group of scan lines is another one of the odd-level scan line and the even-level scan line.

3. The driving method according to claim 1, wherein the X is equal to the Y.

4. The driving method according to claim 1, wherein a time for scanning the frame in the electronic paper display panel is divided into N/2×X+N/2×Y scan time periods.

5. The driving method according to claim 1, wherein the X and the Y are each greater than or equal to 1 and less than or equal to 5.

6. The driving method according to claim 5, wherein the X and the Y are both equal to 2.

7. An electronic paper display device, comprising:
an electronic paper display panel, comprising N scan lines;
a display controller; and
a gate driver on array, coupled to the display controller and the electronic paper display panel, wherein the electronic paper display panel and the gate driver on array are disposed on an electronic paper display substrate,
wherein the display controller controls the gate driver on array to scan the N scan lines,
when one frame of the electronic paper display panel is scanned, the gate driver on array sequentially scans a first group of scan lines among the N scan lines X times, and
after the first group of scan lines is sequentially scanned X times, the gate driver on array sequentially scans a second group of scan lines among the N scan lines Y times, wherein the X and the Y are positive integers.

8. The electronic paper display device according to claim 7, wherein the first group of scan lines is one of an odd-level scan line and an even-level scan line among the N scan lines,
wherein the second group of scan lines is another one of the odd-level scan line and the even-level scan line.

9. The electronic paper display device according to claim 7, wherein the X and the Y are each greater than or equal to 1 and less than or equal to 5.

10. The electronic paper display device according to claim 7, wherein a time for scanning the frame in the electronic paper display panel is divided into N/2×X+N/2×Y scan time periods.

11. The electronic paper display device according to claim 7, wherein the gate driver on array comprises:
N/2 first gate selection circuits, each of the first gate selection circuits respectively coupled to one of odd-level scan lines among the N scan lines, wherein the first gate selection circuits are controlled by a first enable signal; and
N/2 second gate selection circuits, each of the second gate selection circuits respectively coupled to one of even-level scan lines among the N scan lines, wherein the second gate selection circuits are controlled by a second enable signal.
